(19) United States
(12) Patent Application Publication
(10) Pub. No.: US 2024/0252981 A1
(43) Pub. Date: Aug. 1, 2024

(54) CARBON DIOXIDE RECOVERY SYSTEM

(71) Applicant: DENSO CORPORATION, Kariya-city (JP)

(72) Inventors: Yoshiki MORIOKA, Kariya-city (JP); Hiroki Takezaki, Kariya-city (JP)

(21) Appl. No.: 18/619,372

(22) Filed: Mar. 28, 2024

Related U.S. Application Data
(63) Continuation of application No. PCT/JP22/34052, filed on Sep. 12, 2022.

(30) Foreign Application Priority Data
Oct. 1, 2021 (JP) 2021-162761

(51) Int. Cl. B01D 53/32; B01D 53/02; B01D 53/62

(52) U.S. Cl. CPC B01D 53/326; B01D 53/02; B01D 53/62; B01D 2253/25; B01D 2257/504; B01D 2259/812

(57) ABSTRACT

A carbon dioxide recovery system separates carbon dioxide from a carbon dioxide contained gas that contains carbon dioxide by an electrochemical reaction. The carbon dioxide recovery system includes an electrochemical cell including a working electrode and a counter electrode, the working electrode including a carbon dioxide adsorbent. When a voltage is applied between the working electrode and the counter electrode, electrons are supplied from the counter electrode to the working electrode, and the carbon dioxide adsorbent adsorbs carbon dioxide as the electrons are supplied. An electrolytic substance is provided between the working electrode and the counter electrode. The electrolytic substance is a substance having resistance to a redox reaction with at least one of the carbon dioxide contained gas, the working electrode, or the counter electrode when a voltage is applied between the working electrode and the counter electrode.

### CROSS REFERENCE TO RELATED APPLICATIONS

The present application is a continuation application of International Patent Application No. PCT/JP2022/034052 filed on Sep. 12, 2022, which designated the U.S. and claims the benefit of priority from Japanese Patent Application No. 2021-162761 filed on Oct. 1, 2021. The entire disclosures of all of the above applications are incorporated herein by reference.

### TECHNICAL FIELD

The present disclosure relates to a carbon dioxide recovery system that recovers carbon dioxide from a carbon dioxide contained gas that contains carbon dioxide.

### BACKGROUND ART

A gas separation system separates carbon dioxide from a carbon dioxide contained gas (for example, air) by an electrochemical reaction.

### SUMMARY

A carbon dioxide recovery system according to an embodiment of the present disclosure separates carbon dioxide from a carbon dioxide contained gas that contains carbon dioxide by an electrochemical reaction. The carbon dioxide recovery system includes an electrochemical cell including a working electrode and a counter electrode. The working electrode includes a carbon dioxide adsorbent. The carbon dioxide adsorbent is configured to adsorb carbon dioxide in accordance with supply of electrons from the counter electrode to the working electrode in response to application of voltage between the working electrode and the counter electrode. An electrolytic substance is provided between the working electrode and the counter electrode. The electrolytic substance has resistance to a redox reaction with at least one of the carbon dioxide contained gas, the working electrode, or the counter electrode when a voltage is applied between the working electrode and the counter electrode.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic diagram illustrating an overall configuration of a carbon dioxide recovery system according to an embodiment.

FIG. 2 is a perspective view illustrating a carbon dioxide recovery device according to the embodiment.

FIG. 3 is a perspective view illustrating a state in which multiple electrochemical cells are stacked according to the embodiment.

FIG. 4 is a perspective view illustrating an electrochemical cell according to the embodiment.

### DETAILED DESCRIPTION

To begin with, examples of relevant techniques will be described. According to a comparative example, a gas separation system separates carbon dioxide from a carbon dioxide contained gas (for example, air) by an electrochemical reaction. In the gas separation system, a carbon dioxide adsorbent capable of adsorbing carbon dioxide is provided on a working electrode of an electrochemical cell. The carbon dioxide adsorbent is an electroactive species, and adsorption and release of carbon dioxide by the carbon dioxide adsorbent can be switched by changing a potential difference between the working electrode and a counter electrode.

A separator is provided between the working electrode and the counter electrode. The separator is saturated with an electrolytic substance (for example, an electrolytic solution) in order to prevent drying of the electrodes.

However, in the above gas separation system of the comparative example, within a potential range in which a redox reaction does not originally occur in the electrolytic solution, a reaction between the electrolytic solution and an impurity in the carbon dioxide contained gas or a side reaction between the electrolytic solution and an electrode material may occur, and a volatile product may be generated. The volatile product may cause a unpleasant odor or the like, and thus the system may be adversely influenced. In the above gas separation system of the comparative example, when the electrolytic solution is decomposed, performance for adsorbing carbon dioxide may deteriorate, and as a result, the system may be adversely influenced.

In contrast, according to the present disclosure, a carbon dioxide recovery system is capable of preventing an adverse influence caused by an electrolytic substance.

A carbon dioxide recovery system according to an embodiment of the present disclosure separates carbon dioxide from a carbon dioxide contained gas that contains carbon dioxide by an electrochemical reaction. The carbon dioxide recovery system includes an electrochemical cell including a working electrode and a counter electrode. The working electrode includes a carbon dioxide adsorbent. The carbon dioxide adsorbent is configured to adsorb carbon dioxide in accordance with supply of electrons from the counter electrode to the working electrode in response to application of voltage between the working electrode and the counter electrode. An electrolytic substance is provided between the working electrode and the counter electrode. The electrolytic substance has resistance to a redox reaction with at least one of the carbon dioxide contained gas, the working electrode, and the counter electrode when a voltage is applied between the working electrode and the counter electrode.

Accordingly, when a voltage is applied between the working electrode and the counter electrode, it is possible to prevent an occurrence of a redox reaction between the electrolytic substance and at least one of the carbon dioxide contained gas, the working electrode, and the counter electrode. As a result, it is possible to prevent an occurrence of the adverse influence due to the electrolytic substance on the carbon dioxide recovery system.

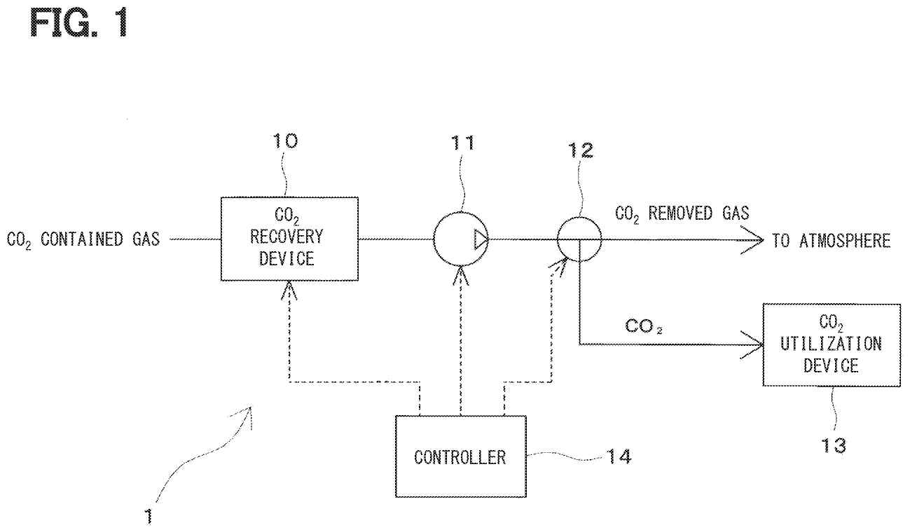

Hereinafter, an embodiment of the present disclosure will be described with reference to the drawings. As illustrated in FIG. 1, a carbon dioxide recovery system 1 according to the present embodiment includes a carbon dioxide recovery device 10, a pump 11, a flow channel switching valve 12, a carbon dioxide utilization device 13, and a controller 14.

The carbon dioxide recovery device 10 is a device that separates and recovers carbon dioxide from a carbon dioxide contained gas. For example, an atmosphere or an exhaust gas of an internal combustion engine can be used as the carbon dioxide contained gas. The carbon dioxide contained gas also contains a gas other than carbon dioxide. The carbon dioxide recovery device 10 is supplied with the carbon dioxide contained gas, and discharges a carbon dioxide removed gas after carbon dioxide is recovered from the carbon dioxide contained gas, or carbon dioxide recovered from the carbon dioxide contained gas. A configuration of the carbon dioxide recovery device 10 will be described in detail later.

With the pump 11, the carbon dioxide contained gas is supplied to the carbon dioxide recovery device 10, and carbon dioxide or the carbon dioxide removed gas is discharged from the carbon dioxide recovery device 10. In the example illustrated in FIG. 1, the pump 11 is provided downstream of the carbon dioxide recovery device 10 in a gas flow direction, but the pump 11 may be provided upstream of the carbon dioxide recovery device 10 in the gas flow.

The flow channel switching valve 12 is a three-way valve that switches a flow channel of a discharged gas of the carbon dioxide recovery device 10. When the carbon dioxide removed gas is to be discharged from the carbon dioxide recovery device 10, the flow channel switching valve 12 switches the flow channel of the discharged gas toward the atmosphere, and when carbon dioxide is to be discharged from the carbon dioxide recovery device 10, the flow channel switching valve 12 switches the flow channel of the discharged gas toward the carbon dioxide utilization device 13.

The carbon dioxide utilization device 13 is a device that utilizes carbon dioxide. For example, a storage tank that stores carbon dioxide or a conversion device that converts carbon dioxide into fuel can be used as the carbon dioxide utilization device 13. As the conversion device, a device that converts carbon dioxide into hydrocarbon fuel such as methane can be used. The hydrocarbon fuel may be gaseous fuel at normal temperature and pressure or liquid fuel at normal temperature and pressure.

The controller 14 includes a known microcomputer including a CPU, a ROM, and a RAM, and a peripheral circuit of the microcomputer. The controller 14 performs various calculations and processing based on control programs stored in the ROM, and controls operations of various control target devices. The controller 14 according to the present embodiment performs operation control on the carbon dioxide recovery device 10, operation control on the pump 11, flow channel switching control on the flow channel switching valve 12, and the like.

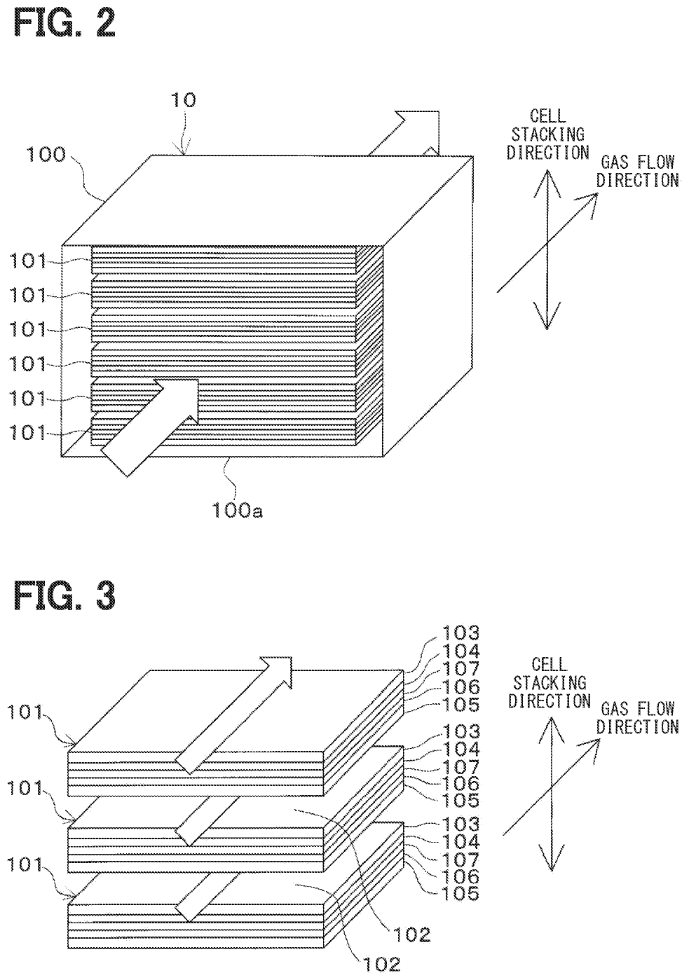

Next, the carbon dioxide recovery device 10 according to the present embodiment will be described with reference to FIGS. 2 to 4. In FIGS. 2 to 4, a direction from the near side of the paper surface to the far side of the paper surface is the gas flow direction, and a vertical direction of the paper surface is a cell stacking direction.

As illustrated in FIG. 2, the carbon dioxide recovery device 10 includes an accommodation portion 100. The accommodation portion 100 is formed in a box shape, and can be formed using, for example, a metal material. Electrochemical cells 101 are accommodated in the accommodation portion 100. The carbon dioxide recovery device 10 adsorbs and desorbs carbon dioxide by an electrochemical reaction of the electrochemical cells 101, and separates and recovers carbon dioxide from the carbon dioxide contained gas.

The accommodation portion 100 has two opening portions. The two opening portions are an introduction portion 100a for introducing the carbon dioxide contained gas into an inside and a discharge portion (not illustrated) for discharging the carbon dioxide removed gas or carbon dioxide from the inside. The gas flow direction is a flow direction when the carbon dioxide contained gas passes through the accommodation portion 100, and is a direction from the introduction portion 100a toward the discharge portion of the accommodation portion 100.

In FIG. 2, the carbon dioxide contained gas flows from the near side of the paper surface to the far side of the paper surface. Therefore, the near side in the drawing is the introduction portion 100a of the accommodation portion 100, and the far side in the drawing is the discharge portion of the accommodation portion 100. The introduction portion 100a and the discharge portion of the accommodation portion 100 may each be provided with opening and closing members for opening and closing the introduction portion 100a and the discharge portion.

As illustrated in FIG. 2, multiple electrochemical cells 101 are stacked and disposed inside the accommodation portion 100. The cell stacking direction in which multiple electrochemical cells 101 are stacked is a direction orthogonal to the gas flow direction. Each electrochemical cell 101 is formed in a plate shape and is disposed such that a plate surface intersects the cell stacking direction.

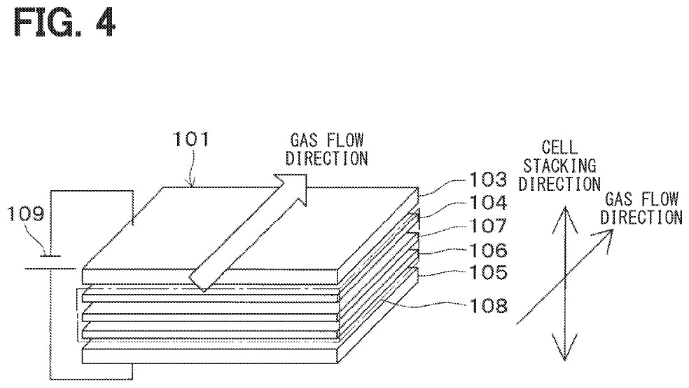

FIG. 3 illustrates a state in which the multiple electrochemical cells 101 are stacked. FIG. 4 illustrates one electrochemical cell 101. FIG. 4 illustrates that components of the electrochemical cell 101, such as a working electrode current collecting layer 103, are provided at intervals, but actually, these components are stacked and disposed in a manner of being in contact with each other.

As illustrated in FIG. 3, a predetermined gap is provided between adjacent electrochemical cells 101. The gap provided between the adjacent electrochemical cells 101 forms a gas flow channel 102 that allows the carbon dioxide contained gas to flow therethrough.

As illustrated in FIGS. 3 and 4, the electrochemical cell 101 includes the working electrode current collecting layer 103, a working electrode 104, a counter electrode current collecting layer 105, a counter electrode 106, and a separator 107. For the adjacent electrochemical cells 101, the working electrode current collecting layer 103 of one electrochemical cell 101 and the counter electrode current collecting layer 105 of another electrochemical cell 101 face each other with the gas flow channel 102 sandwiched therebetween.

As illustrated in FIG. 4, an electrolytic solution 108 serving as an electrolytic substance is provided between the working electrode 104 and the counter electrode 106. In the present embodiment, the working electrode 104, the counter electrode 106, and the separator 107 are saturated with the electrolytic solution 108. The electrolytic solution 108 will be described in detail later.

Each of the working electrode current collecting layer 103, the working electrode 104, the counter electrode current collecting layer 105, the counter electrode 106, and the separator 107 is formed in a plate shape. The electrochemical cell 101 is formed as a stacked body in which the working electrode current collecting layer 103, the working electrode 104, the counter electrode current collecting layer 105, the counter electrode 106, and the separator 107 are stacked. A direction in which the working electrode current collecting layer 103 and the like in each electrochemical cell 101 are stacked is the same as the cell stacking direction in which the multiple electrochemical cells 101 are stacked.

The working electrode current collecting layer 103 is made of a porous conductive material having pores that allow the carbon dioxide contained gas that contains carbon dioxide to pass therethrough. As the working electrode current collecting layer 103, a material having gas permeability and conductivity may be used, and for example, a metal material or a carbonaceous material can be used. In the present embodiment, a metal porous body is used as the working electrode current collecting layer 103.

The working electrode 104 contains a carbon dioxide adsorbent, a conductive substance, and a binder. The carbon dioxide adsorbent, the conductive substance, and the binder are used in a mixture state.

The carbon dioxide adsorbent adsorbs carbon dioxide by receiving electrons, and desorbs the adsorbed carbon dioxide by releasing the electrons. For example, polyanthraquinone can be used as the carbon dioxide adsorbent.

The conductive substance forms a conductive path toward the carbon dioxide adsorbent. For example, a carbon material such as a carbon nanotube, carbon black, and graphene can be used as the conductive substance.

The binder is provided to hold the carbon dioxide adsorbent or the conductive substance. For example, a conductive resin can be used as the binder. An epoxy resin containing Ag or the like as a conductive filler, a fluororesin such as polytetrafluoroethylene (PTFE) or polyvinylidene fluoride (PVDF), or the like can be used as the conductive resin.

The counter electrode current collecting layer 105 is made of a conductive material. For example, a metal material or a carbonaceous material can be used as the counter electrode current collecting layer 105. In the present embodiment, a metal plate is used as the counter electrode current collecting layer 105.

The counter electrode 106 contains an electroactive auxiliary material, a conductive substance, and a binder. Since the conductive substance and the binder in the counter electrode 106 have the same configuration as those in the working electrode 104, description thereof will be omitted. In the present embodiment, the counter electrode 106 is made of a material containing an active material serving as an electron donor.

The electroactive auxiliary material in the counter electrode 106 is an auxiliary electroactive species that transfers and receives electrons to and from the carbon dioxide adsorbent in the working electrode 104. For example, a metal complex capable of transferring and receiving electrons by changing a valence of a metal ion can be used as the electroactive auxiliary material. Examples of such a metal complex include a cyclopentadienyl metal complex such as ferrocene, nickelocene, and cobaltocene, or a porphyrin metal complex. These metal complexes may be polymers or monomers.

The separator 107 is disposed between the working electrode 104 and the counter electrode 106, and separates the working electrode 104 from the counter electrode 106. The separator 107 is an insulating ion-permeable membrane that prevents physical contact between the working electrode 104 and the counter electrode 106 to prevent an electrical short circuit and that allows ions to permeate. A cellulose film, a polymer, a composite material of a polymer and ceramics, or the like can be used as the separator 107.

The electrochemical cell 101 is provided with a power supply 109 connected to the working electrode current collecting layer 103 and the counter electrode current collecting layer 105. The power supply 109 can change a potential difference between the working electrode 104 and the counter electrode 106 by applying a predetermined voltage to the working electrode 104 and the counter electrode 106. The working electrode 104 is a negative electrode, and the counter electrode 106 is a positive electrode.

The electrochemical cell 101 can operate to switch, by changing the potential difference between the working electrode 104 and the counter electrode 106, between a carbon dioxide recovery mode in which carbon dioxide is recovered by the working electrode 104 and a carbon dioxide release mode in which carbon dioxide is released from the working electrode 104. The carbon dioxide recovery mode is a charge mode for charging the electrochemical cell 101, and the carbon dioxide release mode is a discharge mode for discharging the electrochemical cell 101.

In the carbon dioxide recovery mode, a first voltage V1 is applied between the working electrode 104 and the counter electrode 106, and electrons are supplied from the counter electrode 106 to the working electrode 104. At the first voltage V1, a working-electrode potential is lower than a counter-electrode potential. The first voltage V1 may be, for example, within a range of 0.5 V to 2.0 V.

In the carbon dioxide release mode, a second voltage V2 is applied between the working electrode 104 and the counter electrode 106, and electrons are supplied from the working electrode 104 to the counter electrode 106. The second voltage V2 is a voltage different from the first voltage V1. The second voltage V2 may be a voltage lower than the first voltage V1, and a magnitude relationship between the working-electrode potential and the counter-electrode potential is not limited. That is, in the carbon dioxide release mode, the working-electrode potential may be lower than the counter-electrode potential, the working-electrode potential may be equal to the counter-electrode potential, or the working-electrode potential may be higher than the counter-electrode potential.

Next, the electrolytic solution 108 according to the present embodiment will be described. In the carbon dioxide recovery system 1 according to the present embodiment, a substance having resistance to at least one of an addition reaction and a substitution reaction with at least one of the carbon dioxide contained gas, the working electrode 104, and the counter electrode 106 is used as the electrolytic solution 108. For example, a substance in which at least one of the addition reaction and the substitution reaction does not occur with at least one of the carbon dioxide contained gas, the working electrode 104, and the counter electrode 106 can be used as the electrolytic solution 108.

Specifically, when a voltage is applied between the working electrode 104 and the counter electrode 106, a substance having resistance to a redox reaction with at least one of the carbon dioxide contained gas, the working electrode 104, and the counter electrode 106 can be used as the electrolytic solution 108. For example, when the voltage is applied between the working electrode 104 and the counter electrode 106, a substance that does not exhibit the redox reaction with at least one of the carbon dioxide contained gas, the working electrode 104, and the counter electrode 106 can be used as the electrolytic solution 108.

More specifically, when a voltage ranging from the first voltage V1 or more to the second voltage V2 or less is applied between the working electrode 104 and the counter electrode 106, a substance having resistance to a redox reaction with at least one of the carbon dioxide contained gas, the working electrode 104, and the counter electrode 106 can be used as the electrolytic solution 108. For example, when the voltage ranging from the first voltage V1 or more to the second voltage V2 or less is applied between the working electrode 104 and the counter electrode 106, a substance that does not exhibit the redox reaction with at least one of the carbon dioxide contained gas, the working electrode 104, and the counter electrode 106 can be used as the electrolytic solution 108.

When a voltage is applied between the working electrode 104 and the counter electrode 106, a substance having resistance to a decomposition reaction at normal temperature and pressure can be used as the electrolytic solution 108. For example, when the voltage is applied between the working electrode 104 and the counter electrode 106, a substance that does not exhibit the decomposition reaction at normal temperature and pressure can be used as the electrolytic solution 108.

More specifically, when a voltage ranging from the first voltage V1 or more to the second voltage V2 or less is applied between the working electrode 104 and the counter electrode 106, a substance having resistance to a decomposition reaction can be used as the electrolytic solution 108. For example, when the voltage ranging from the first voltage V1 or more to the second voltage V2 or less is applied between the working electrode 104 and the counter electrode 106, a substance that does not exhibit the decomposition reaction can be used as the electrolytic solution 108.

A substance having stability against a constituent material of the electrochemical cell 101 can be used as the electrolytic solution 108. That is, a substance having resistance to reactions with the constituent material of the electrochemical cell 101 can be used as the electrolytic solution 108.

A substance in which a volatile product is less likely to be generated by an electrochemical reaction can be used as the electrolytic solution 108. For example, a substance in which a volatile product is less likely to be generated by the electrochemical reaction can be used as the electrolytic solution 108 as compared with a case in which 1-ethyl-3-methylimidazolium dicyanamide [Emin] [N(CN)₂] is used as the electrolytic solution 108. A substance in which a volatile product is not generated by the electrochemical reaction can be used as the electrolytic solution 108.

An ionic liquid can be used as the electrolytic solution 108. The ionic liquid is a salt of a liquid that is non-volatile at normal temperature and pressure.

A cation species represented by any one of the following general formulas (1) to (6) can be used as a cation species of the ionic liquid.

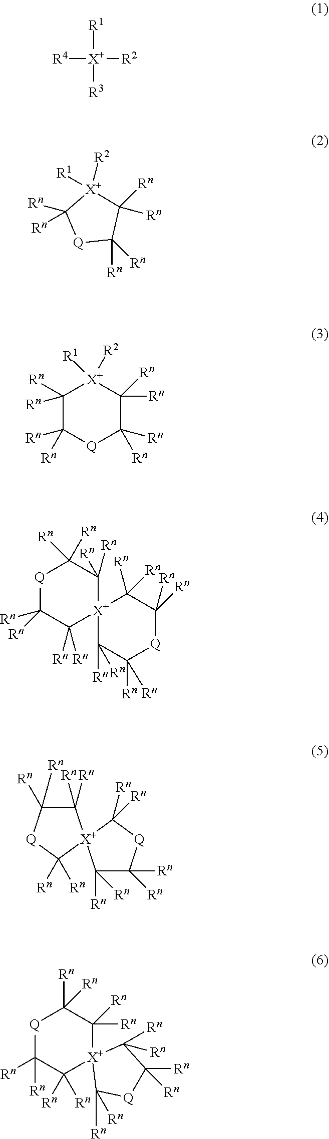

In the general formulas (1) to (6), X is an atom containing a Group 15 element serving as a monovalent cation. In the general formulas (1) to (6), Q is any one of an O atom, an S atom, and a group represented by the following general formula (7).

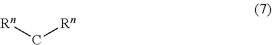

In the general formulas (1) to (6), R¹ to R⁴ each independently represent a group excluding hydrogen. In the general formulas (2) to (7), Rr's each independently represent a group. That is, Rⁿ may be hydrogen or a chemical group other than hydrogen.

In the general formulas (1) to (6), R¹ to R⁴ may each independently be any one of an alkyl group, an alkoxyalkyl group, an alkenyl group, an alkynyl group, an aryl group, and a heterocyclic group. In the general formulas (1) to (6), groups represented by R¹ to R⁴ may each independently be a group having 1 to 10 carbon atoms.

In the general formulas (2) to (7), Rⁿ's may each independently be any one of hydrogen, an alkyl group, an alkoxyalkyl group, an alkenyl group, an alkynyl group, an aryl group, and a heterocyclic group. In the general formulas (2) to (7), the groups represented by Rⁿ's may each independently be hydrogen and a group having 1 to 5 carbon atoms.

In the general formulas (1) to (6), X may be an atom not containing an unpaired electron. Specifically, in the general formulas (1) to (6), X may be an N atom or a P atom.

An anion species not exhibiting a hydrolysis reaction can be used as an anion species of the ionic liquid. Specifically, a monoatomic anion or a polyatomic anion in which a side chain bonded to a central atom contains an atom other than halogen can be used as the anion species of the ionic liquid. That is, in the carbon dioxide recovery system 1 according to the present embodiment, an anion species in which a central atom is an inorganic element and a side chain bonded to the central atom is only formed of halogen is not used as the anion species of the ionic liquid.

Specifically, the anion species of the ionic liquid may be an organic anion containing multiple fluorine atoms as represented by the following chemical formula (8).

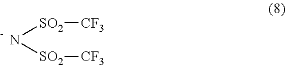

In carbon dioxide recovery systems in the related art, in the carbon dioxide recovery device 10, a contaminant from an environmental atmosphere may be converted into a radical as electrons are supplied to the working electrode 104 or the counter electrode 106, which may cause a nucleophilic addition reaction with the electrolytic solution 108, make a molecular structure unstable, and cause a decomposition reaction. In particular, in the carbon dioxide recovery systems in the related art, the electrolytic solution 108 always comes into contact with an environmental gas (atmosphere or the like) which is a carbon dioxide contained gas, and oxygen (O₂) or water (H₂O) as a radical source is continuously supplied, and thus an influence of the addition reaction or the substitution reaction on the electrolytic solution 108 is more evident.

In contrast, in the carbon dioxide recovery system 1 according to the present embodiment, a substance having resistance to at least one of the addition reaction and the substitution reaction with at least one of the carbon dioxide contained gas, the working electrode 104, and the counter electrode 106 is used as the electrolytic solution 108. When a voltage is applied between the working electrode 104 and the counter electrode 106, a substance having resistance to the decomposition reaction at normal temperature and pressure is used as the electrolytic solution 108. Accordingly, it is possible to prevent an occurrence of the addition reaction or the substitution reaction, or an occurrence of the decomposition reaction in the electrolytic solution 108 with at least one of the carbon dioxide contained gas, the working electrode 104, and the counter electrode 106.

In the present embodiment, when a voltage ranging from the first voltage V1 or more to the second voltage V2 or less is applied between the working electrode 104 and the counter electrode 106, a substance having resistance to the redox reaction or a substance having resistance to the decomposition reaction with at least one of the carbon dioxide contained gas, the working electrode 104, and the counter electrode 106 is used as the electrolytic solution 108. In this manner, by limiting a range of a voltage applied to the carbon dioxide recovery system 1, it is possible to prevent a radical generation reaction of the contaminant from the environmental atmosphere or the decomposition reaction of the electrolytic solution 108 alone.

In the present embodiment, the counter electrode 106 is made of a material containing an active material serving as an electron donor. Accordingly, electrons donating is performed on the counter electrode 106, and an electron-withdrawing potential can be lowered.

In the present embodiment, the electrolytic solution 108 is an ionic liquid, and the cation species represented by any one of the above general formulas (1) to (6) is used as the cation species of the ionic liquid. Accordingly, a substance having a double bond in which an addition reaction is likely to occur in a valence part or a substance having a cyclic structure in which a substitution reaction is likely to occur is not used as the cation species, and thus it is possible to improve stability against a redox reaction with a contaminant from an environmental atmosphere.

In the present embodiment, the electrolytic solution 108 is an ionic liquid, and the anion species having resistance to the hydrolysis reaction is used as the anion species of the ionic liquid. Accordingly, the electrolytic solution 108 can be prevented from reacting with water contained in the carbon dioxide contained gas to cause a decomposition reaction. Hydrophobicity of the electrolytic solution 108 is improved, and radical generation due to water contained in the carbon dioxide contained gas can be prevented.

In the present embodiment, a substance having stability against the constituent material of the electrochemical cell 101 is used as the electrolytic solution 108. Accordingly, it is possible to reduce the generation of gas due to the reaction between the electrolytic solution 108 and the constituent material of the electrochemical cell 101 eluted into the electrolytic solution 108.

In the present embodiment, a substance in which a volatile product is less likely to be generated by the electrochemical reaction is used as the electrolytic solution 108. Specifically, a substance in which a volatile product is not generated by the electrochemical reaction is used as the electrolytic solution 108.

Accordingly, a volatile product can be prevented from being generated even when a reaction between the electrolytic solution 108 and an impurity in the carbon dioxide contained gas or a side reaction between the electrolytic solution 108 and an electrode material occurs. As a result, it is possible to prevent an occurrence of an adverse influence due to the electrolytic solution 108 on the carbon dioxide recovery system 1. Specifically, it is possible to prevent generation of a bad odor when a voltage is applied to the electrochemical cell 101. A purity of the recovered carbon dioxide can be improved.

A side reaction in which a volatile product is generated does not occur, and thus it is possible to prevent charge transfer in the electrochemical cell 101 without storage of charges or an adsorption reaction of carbon dioxide. Accordingly, energy efficiency during recovery of carbon dioxide can be improved. Characteristic deterioration of the working electrode 104 and the counter electrode 106 can be prevented.

The present disclosure is not limited to the above-described embodiment, and various modifications can be made as follows without departing from the gist of the present disclosure.

For example, in the above-described embodiment, an example in which the electrolytic solution 108 in a liquid state is used as the electrolytic substance has been described, but the electrolytic substance is not limited to the electrolytic solution 108. As the electrolytic substance, an ionic liquid gel obtained by gelling an ionic liquid may be used, or a solid electrolyte in a solid state may be used.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A carbon dioxide recovery system for separating carbon dioxide from a carbon dioxide contained gas that contains carbon dioxide by an electrochemical reaction, the carbon dioxide recovery system comprising:
an electrochemical cell including a working electrode and a counter electrode, the working electrode including a carbon dioxide adsorbent, wherein
the carbon dioxide adsorbent is configured to adsorb carbon dioxide in accordance with supply of electrons from the counter electrode to the working electrode in response to application of voltage between the working electrode and the counter electrode,
an electrolytic substance is provided between the working electrode and the counter electrode, and
the electrolytic substance has resistance to a redox reaction with at least one of the carbon dioxide contained gas, the working electrode, or the counter electrode when a voltage is applied between the working electrode and the counter electrode.

2. The carbon dioxide recovery system according to claim 1, wherein
the electrolytic substance has resistance to a decomposition reaction at normal temperature and pressure when a voltage is applied between the working electrode and the counter electrode.

3. The carbon dioxide recovery system according to claim 1, wherein
the carbon dioxide adsorbent is configured to adsorb carbon dioxide in accordance with supply of electrons from the counter electrode to the working electrode in response to application of first voltage between the working electrode and the counter electrode,
the carbon dioxide adsorbent is configured to desorb carbon dioxide by releasing electrons from the working electrode to the counter electrode in response to application of second voltage between the working electrode and the counter electrode, the second voltage being different from the first voltage, and
the electrolytic substance has the resistance to the redox reaction with at least one of the carbon dioxide contained gas, the working electrode, or the counter electrode when a voltage ranging from the first voltage or more to the second voltage or less is applied between the working electrode and the counter electrode.

4. The carbon dioxide recovery system according to claim 2, wherein
the carbon dioxide adsorbent is configured to adsorb carbon dioxide in accordance with supply of electrons from the counter electrode to the working electrode in response to application of first voltage between the working electrode and the counter electrode,
the carbon dioxide adsorbent is configured to desorb carbon dioxide by releasing electrons from the working electrode to the counter electrode in response to application of second voltage between the working electrode and the counter electrode, the second voltage being different from the first voltage, and
the electrolytic substance has the resistance to the decomposition reaction when a voltage ranging from the first voltage or more to the second voltage or less is applied between the working electrode and the counter electrode.

5. The carbon dioxide recovery system according to claim 3, wherein
the counter electrode is made of a material having an active material serving as an electron donor.

6. The carbon dioxide recovery system according to claim 1, wherein
the electrolytic substance is an ionic liquid,
a cation species of the ionic liquid is a cation species represented by one of the following general formulas (1) to (6): 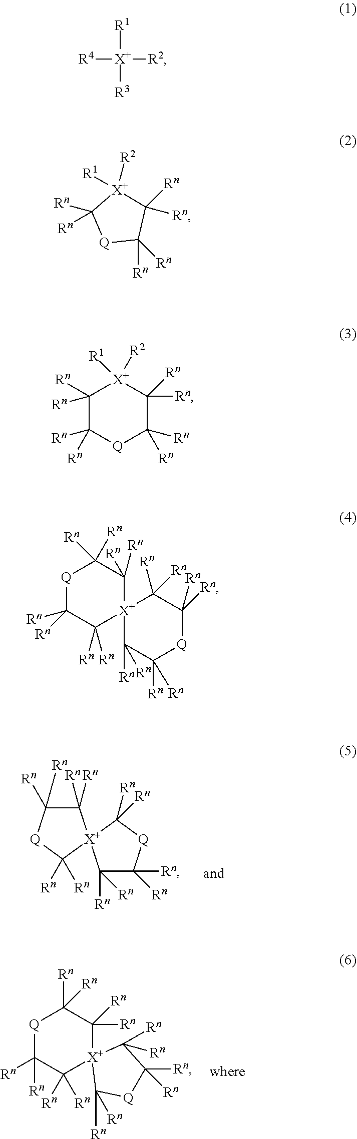
X is an atom containing a Group 15 element serving as a monovalent cation,
Q is an O atom, an S atom, or a group represented by the general formula (7): 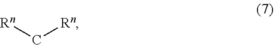
R¹ to R⁴ each independently represent a group excluding hydrogen, and
Rⁿ's each independently represent a group.

7. The carbon dioxide recovery system according to claim 6, wherein
in the general formulas (1) to (6), R¹ to R⁴ are each independently an alkyl group, an alkoxyalkyl group, an alkenyl group, an alkynyl group, an aryl group, or a heterocyclic group, and
in the general formulas (2) to (7), Rⁿ's are each independently hydrogen, an alkyl group, an alkoxyalkyl group, an alkenyl group, an alkynyl group, an aryl group, or a heterocyclic group.

8. The carbon dioxide recovery system according to claim 7, wherein
in the general formulas (1) to (6), groups represented by R¹ to R⁴ are each independently a group having 1 to 10 carbon atom, and
in the general formulas (2) to (7), groups represented by Rⁿ's are each independently hydrogen or a group having 1 to 5 carbon atoms.

9. The carbon dioxide recovery system according to claim 6, wherein
in the general formulas (1) to (6), X is an N atom or a P atom.

10. The carbon dioxide recovery system according to claim 6, wherein
in the general formulas (1) to (6), X is an atom not having an unpaired electron.

11. The carbon dioxide recovery system according to claim 1, wherein
the electrolytic substance is an ionic liquid, and
an anion species of the ionic liquid is an anion species having resistance to a hydrolysis reaction.

12. The carbon dioxide recovery system according to claim 11, wherein
the anion species of the ionic liquid is a monoatomic anion or a polyatomic anion in which a side chain bonded to a central atom has an atom other than halogen.

13. The carbon dioxide recovery system according to claim 12, wherein
the anion species of the ionic liquid is an organic anion having a plurality of fluorine atoms.

14. The carbon dioxide recovery system according to claim 1, wherein
the electrolytic substance is a substance having stability against a constituent material of the electrochemical cell.
